(19) United States
(12) Patent Application Publication
(10) Pub. No.: US 2017/0235396 A1
(43) Pub. Date: Aug. 17, 2017

(54) THIN FILM TRANSISTOR ARRAY SUBSTRATE, MANUFACTURING METHOD THEREOF AND TOUCH DISPLAY PANEL

(71) Applicant: Wuhan China Star Optoelectronics Technology Co., Ltd., Wuhan (CN)

(72) Inventor: Qiang GONG, Wuhan (CN)

(73) Assignee: Wuhan China Star Optoelectronics Technology Co., Ltd., Wuhan (CN)

(21) Appl. No.: 15/274,314

(22) Filed: Sep. 23, 2016

(30) Foreign Application Priority Data
Feb. 16, 2016 (CN) 201610087081.2

(51) Int. Cl. G06F 3/041; G02F 1/1333; G02F 1/1339; G02F 1/1368; G02F 1/1362; G06F 3/047; G02F 1/1335

(52) U.S. Cl. CPC G06F 3/0412; G06F 3/0416; G06F 3/047; G02F 1/13338; G02F 1/133514; G02F 1/1368; G02F 1/136286; G02F 1/13394; G06F 2203/04103; G02F 2001/133357; G02F 2001/13398; G02F 2001/136295

(57) ABSTRACT

The invention provides a thin film transistor array substrate, a manufacturing method thereof, and a touch control display panel. The touch control display panel includes a color filter substrate, a thin film transistor array substrate mentioned above, and a liquid crystal layer and photo spacers located between the two substrates. When the color filter substrate combined with the thin film transistor array substrate face to face, the photo spacers is located therebetween. The thin film transistor array substrate has a planarization layer therein. The planarization layer is recessed to a plurality of grooves arranged at intervals. A plurality of touch control electrode lead wires are received in the plurality of grooves. Upper surfaces of the plurality of touch control electrode lead wires and an upper surface of the planarization layer are in a same plane.

### BACKGROUND OF THE INVENTION

1. Field of the Invention

The present invention relates to touch technology and display technology fields, especially relates to a thin film transistor array substrate, a manufacturing method thereof, and a touch display panel having the thin film transistor array substrate.

2. Description of Related Art

With the development of touch technology and display technology, touch display panels have been widely used in smart phones, tablet computers, and other intelligent electronic products, which brings more convenient experience for human computer interaction.

At present, according to their composition structures, touch display panels can be divided into add on mode touch panels, on-cell touch panels, in-cell touch panels, etc., wherein the touch control electrode of the in-cell touch panel is embedded into the inner side of a touch panel, which can effectively reduce the thickness of the whole module to make it much thinner and more portable. Therefore, the in-cell touch panel is bound to become the developing direction of touch display panel in future. The developed self-capacitance and in-cell touch panel technology is to divide the common electrode of the active area into cell blocks as touch control electrodes, and to connect output pins of IC to every cell block (touch control electrode) through lead wires. Thus, when the technology is applied to a liquid crystal display panel, a space is needed to be designed for receiving lead wires in the corresponding structure of the liquid crystal display panel.

Normally, a liquid crystal display panel mainly includes a color filter (CF) substrate, a thin film transistor (TFT) array substrate, a liquid crystal layer placed between the color filter substrate and the thin film transistor array substrate, a photo spacer (PS), and a sealant. The photo spacer may be designed in different heights and thicknesses, which not only meets the requirement of resisting the pressure applied on the liquid crystal display panel, but also meets the requirement of supporting and maintaining the distance between the above two substrates. In addition, the height and the standing position of the photo spacer will affect the cell manufacturing process (that is, the fitting process between the color filter substrate and the thin film transistor array substrate) of a liquid crystal display.

There is a planarization layer disposed on the thin film transistor array substrate in the liquid crystal display panel with a low temperature poly-silicon (LTPS) thin film transistor, which makes the standing portion of the photo spacer on the planarization layer be relatively flat and stable when the color filter substrate and the thin film transistor array substrate are combined together face to face. However, when the self capacitive in-cell touch panel technology is applied in the liquid crystal display panel mentioned above, lead wires used for connecting touch control electrodes and output terminals of IC may be disposed on the planarization layer, and the location of the lead wires right corresponds to the location of the photo spacer, that is, the photo spacer is standing on locations at which the lead wires protrudes toward outside. If the color filter substrate cannot match with the thin film transistor array substrate accurately, the photo spacer will slip off from the lead wires, thereby affecting the real thickness of a liquid crystal display to cause the bad display effect.

As shown in FIG. 1, a photo spacer with a double column structure is generally used in a liquid crystal display panel with a small size. A first cylindrical spacer 11 and a second cylindrical spacer 12 having different heights are placed on a color filter substrate 1 as the photo spacers. The first cylindrical spacer, higher but distributed sparsely, is mainly used for maintaining a distance between the color filter substrate and the thin film transistor array substrate after the two substrates couple with each other (that is, a thickness of the liquid crystal display panel after the color filter substrate and the thin film transistor array substrate are combined). The second cylindrical spacer, lower but distributed densely, is used for increasing a capacity of the liquid crystal display panel resisting a compression. However, as shown in FIG. 1 to FIG. 3, a first touch control electrode lead wire 41 and a second touch control electrode lead wire 42 which are used for connecting the touch control electrode and the output terminal of IC are placed on a planarization layer 3 of the thin film transistor array substrate 2. Other film layer 6 (such as a passivation layer, a ITO film layer, ect.) is placed on the first touch control electrode lead wire 41 and the second touch control electrode lead wire 42, and the locations at which the first touch control electrodes lead wire 41 and the second touch control electrode lead wire 42 are disposed right correspond to the standing positions of the first cylindrical spacer 11 and the second cylindrical spacer 12, respectively. In this regard, as shown in FIG. 4, when the color filter substrate 1 and the thin film transistor array substrate 2 are combined together, since a height of the first cylindrical spacer 11 is higher, a lower surface of the first cylindrical spacer 11 contacts the film layer 6 and stands thereon, and the standing position of the first cylindrical spacer 11 corresponds to a location at which the first touch control electrode lead wire 41 is located under the film layer 6. Due to a lower height of the second cylindrical spacer 12, there is a gap kept between the second cylindrical spacer 12 and the film layer 6, and the location of the gap corresponds to the second touch electrode lead wire 42 under the film layer 6. However, as shown in FIG. 5, if the color filter substrate 1 cannot match with the thin film transistor array substrate 2 accurately, the first cylindrical spacer 11 and the second cylindrical spacer 12 may be mismatched from the locations at which the first and second touch control electrode lead wires 41 and 42 are disposed respectively. Although the cylindrical spacers can still stand on the film layer, it is the planarization layer corresponding to a location under the standing position of the cylindrical spacers, instead of the touch control electrode lead wire, which may reduce the real thickness of the liquid crystal display panel and affect the final display effect.

### SUMMARY OF THE INVENTION

In order to overcome the deficiency of the related art, the purpose of the present invention is to provide a thin film transistor array substrate, a manufacturing method thereof and a touch display panel to solve the problem that the real thickness of a touch control display panel has a deviation because a poor accuracy of matching and combining a color filter substrate and the TFT array substrate.

The present invention includes the following three aspects. Aspect1: the present invention provides a thin film transistor array substrate. The thin film transistor array substrate has a planarization layer disposed therein. The planarization layer is recessed toward its inner side to form a plurality of grooves arranged at intervals. A plurality of touch control electrode lead wires are received in the plurality of grooves. Upper surfaces of the plurality of touch control electrode lead wires and an upper surface of the planarization layer are in the same plane.

As a further improvement, the plurality of grooves are formed by exposing and developing the planarization layer via a half tone mask.

As a further improvement, an opening passing through the planarization layer is further disposed in the planarization layer, and the opening is formed by exposing and developing the planarization layer via a common mask.

As a further improvement, a film layer is further disposed over the touch control electrode lead wires and the planarization layer, and an upper surface of the film layer is planar.

Aspect2: the present invention provides a manufacturing method of a film transistor array substrate, and the manufacturing method includes: providing a thin film transistor array substrate having a planarization layer; exposing and developing the planarization layer to enable the planarization layer to be recessed toward its inner side to form a plurality of grooves arranged at intervals; and forming a touch control electrode lead wire in each of the grooves to enable an upper surface of the touch control electrode lead wire and an upper surface of the planarization layer to be in the same plane.

As an embodiment of the manufacturing method according to the present invention, the film transistor array substrate is divided into a first area and a second area, and the step of exposing and developing the planarization layer includes: partially exposing the planarization layer located in the first area via a halt tone mask; and developing the planarization layer to form the plurality of grooves.

As a further improvement, the step of exposing and developing the planarization layer further includes: completely exposing the flattening layer located in the second area via a common mask; and developing the planarization layer to form an opening passing through the planarization layer.

As an embodiment of the manufacturing method according to the present invention, the step of forming a touch control electrode lead wire includes: depositing a metal layer on the planarization layer having the grooves; and etching the metal layer to remove a part of the metal layer located on the upper surface of the planarization layer, thereby remaining a part of the metal layer received in the grooves as the touch control electrode lead wire.

Aspect3: the present invention also provides a touch control display panel which includes: a color filter substrate; a thin film transistor array substrate manufactured by the method mentioned above, wherein the color filter substrate and the thin film transistor substrate is disposed facing to each other; and a liquid crystal layer placed between the color filter substrate and the thin film transistor array substrate. A plurality of photo spacers extends in a direction from a lower surface of the color filter substrate towards the thin film transistor array substrate. A planarization layer is placed on an upper surface of a base of the thin film transistor array substrate. The planarization layer is recessed to form a plurality of grooves. A plurality of touch control electrode lead wires are received in the plurality of grooves respectively. Upper surfaces of the plurality of touch control electrode lead wires and an upper surface of the planarization layer are in the same plane. After the lower surface of the color filter substrate and the upper surface of the thin film transistor array substrate are combined face to face, all or a part of the plurality of photo spacers support between the color filter substrate and the thin film transistor array substrate, and projections of the plurality of photo spacers on the thin film transistor array substrate correspond to the plurality of touch control electrode lead wires, respectively..

As a further improvement, a film layer is further located on the planarization layer and the touch control electrode lead wires. The film layer is planar. All or a part of the plurality of photo spacers support between a lower surface of the color film substrate and an upper surface of the film layer.

As a further improvement, the plurality of photo spacers include a first cylindrical spacer and a second cylindrical spacer. A height of the first cylindrical spacer is higher than a height of the second cylindrical spacer along a direction substantially perpendicular to the color filter substrate. The plurality of touch control electrode lead wires includes a first touch control electrode lead wire and a second touch control electrode lead wire. After a lower surface of the color filter substrate and an upper surface of the film layer are combined face to face, the first cylindrical spacer supports between the color filter substrate and a portion of the film layer under which the first touch control electrode lead wire is disposed. The second cylindrical spacer is disposed above a portion of the film layer under which the second touch control electrode lead wire is disposed, and is spaced apart from the film layer by a distance.

As a further improvement, the plurality of grooves are formed by exposing and developing the planarization layer via a half tone mask.

As a further improvement, an opening passing through the planarization layer is further disposed in the planarization layer, and the opening is formed by exposing and developing the planarization layer via a common mask.

As a further improvement, a film layer is further disposed over the touch control electrode lead wires and the planarization layer, and an upper surface of the film layer is planar.

Compared with the related art, the benefit of the present invention is listed as follows.

In the present invention, the planarization layer on the thin film transistor array substrate is optimally designed. The grooves are disposed on the planarization layer to receive the touch control electrode lead wires, so that the touch control electrode lead wires do not protrude from the planarization layer but in the same plane with the planarization layer, thereby making the upper surface of the film layer formed above the touch control electrode lead wires to be also a planar. In such a structure, even if a poor accuracy of combining the color filter substrate and the thin film transistor array substrate causes that the photo spacers cannot correspond to the locations of the touch control electrode lead wires accurately, but move to stand on a portion of the film layer under which the planarization layer is disposed, the thickness of the liquid crystal display panel cannot be changed due to such a move, that's because the touch control electrode lead wires are formed in the same plane as the planarization layer, rather than protrude from it, so that the film layer disposed above both the touch control electrode lead wires and the planarization layer is also planar. Thus, the possibility that the liquid crystal display panel is reduced on thickness and deteriorated on display effect due to the photo spacers disposed offset from the touch control electrode lead wires after combining the color filter substrate and the thin film transistor substrate.

### BRIEF DESCRIPTION OF THE DRAWINGS

FIG. 1 is an exploded, schematic view of a liquid crystal display panel in accordance with the related art.

FIG. 2 is a top view of the photo spacers placed on the CF substrate in accordance with the related art.

FIG. 3 is a top view of the photo spacers placed on the TFT array substrate in accordance with the related art.

FIG. 4 is a schematic view of the liquid crystal display panel combined with the CF substrate and the TFT array substrate facing to each other in accordance with the related art.

FIG. 5 is a schematic view of the liquid crystal display panel when the CF substrate mismatches to the TFT array substrate with a deviation in accordance with the related art.

FIG. 6 is a schematic view of the touch control display panel combined with the CF substrate and the TFT array substrate facing to each other in accordance with an embodiment of the present disclosure.

FIG. 7 is a top view of a location where the photo spacers are placed on the CF substrate in accordance with an embodiment of the present disclosure.

FIG. 8 is a top view of a location where the photo spacers are placed on the TFT array substrate in accordance with an embodiment of the present disclosure.

FIG. 9 is a schematic view of the liquid crystal display panel when the CF substrate mismatches to the TFT array substrate with a deviation in accordance with an embodiment of the present disclosure.

FIG. 10 to 14 are flow charts of manufacturing a thin film transistor array substrate in accordance with an embodiment of the present invention.

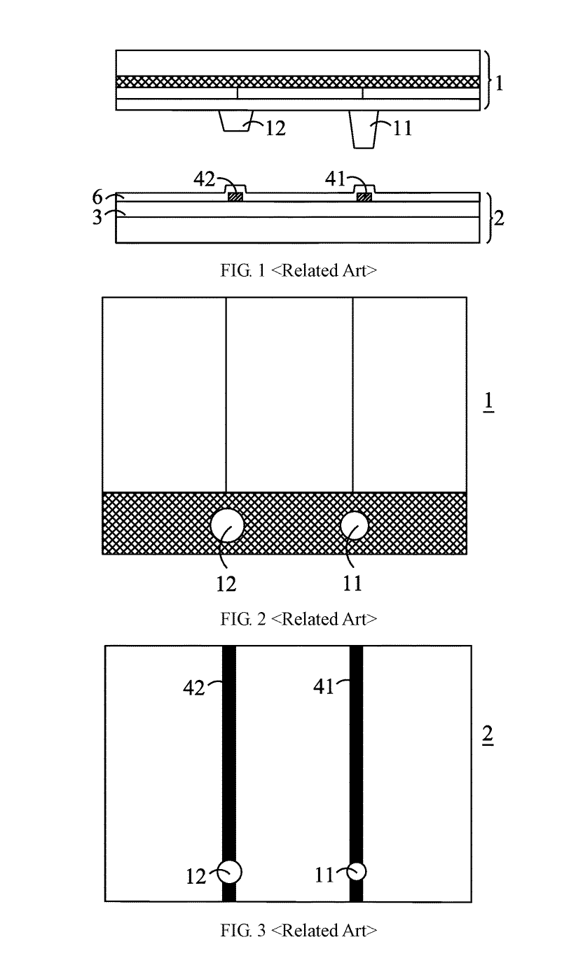

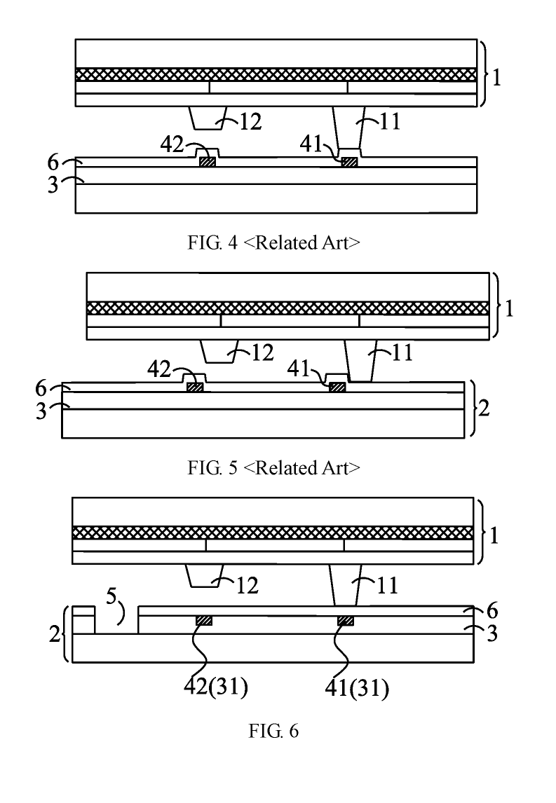

### DETAILED DESCRIPTION OF THE PREFERRED EMBODIMENT

The following content combines with the figures and the embodiments for describing the present invention in detail. It is obvious that the following embodiments are only some embodiments of the present invention. For an ordinary person skilled in the art without any creative effort, other embodiments obtained thereby are still covered by the present invention.

Referring to FIG. 6, a touch control display panel in accordance with an embodiment includes a color filter (CF) substrate 1, a thin film transistor (TFT) array substrate 2, and a liquid crystal layer (not shown) placed between the color filter substrate 1 and the thin film transistor array substrate 2.

A first cylindrical spacer 11 and a second cylindrical spacer 12 are disposed on the color filter substrate 1, and extend in a direction from a lower surface of the color filter substrate 1 toward the thin film transistor array substrate 2. A height of the first cylindrical spacer 11 is higher than a height of the second cylindrical spacer 12 along a direction substantially perpendicular to the color filter substrate 1. Each of the first and second spacers are cylinders with a cross-section area gradually decreased from the top to the bottom. A planarization layer 3 is disposed on an upper surface of the thin film transistor array substrate 2, and the planarization layer 3 are recessed toward its inner side to form a plurality of grooves 31 arranged at intervals. A first touch control electrode lead wire 41 and a second touch control electrode lead wire 42 are received in the grooves 31 and upper surfaces of the first and second touch control electrode lead wires are both at the same level as an upper surface of the planarization layer, i.e., in the same plane. A film layer 6 is further disposed on the planarization layer 3, the first touch control electrode lead wire 41 and the second touch control electrode lead wire 42, and an upper of the film layer 6 is also planar.

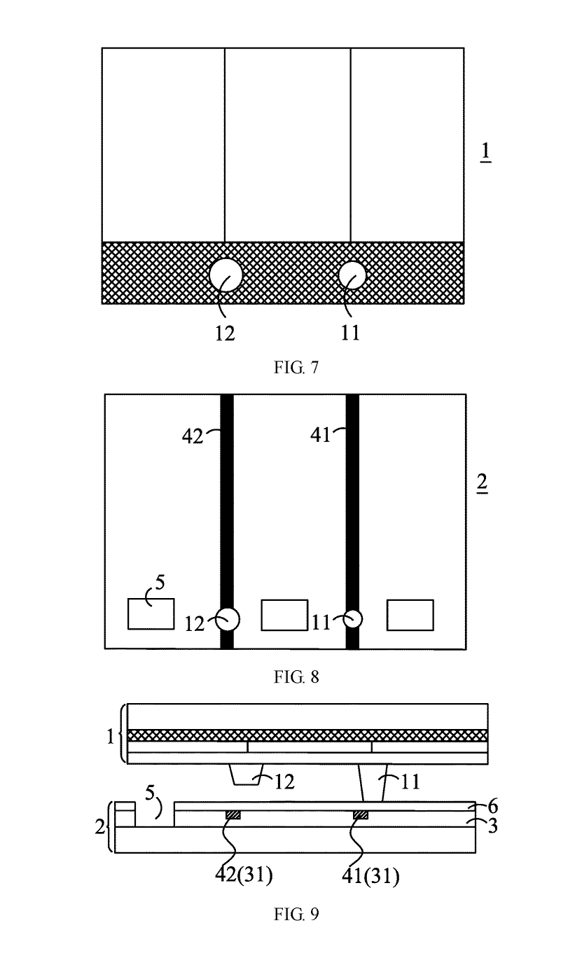

Referring to FIGS. 6 to 8, after the color filter substrate 1 and the thin film transistor array substrate 2 are combined facing to each other, the standing position of the first photo spacer 11 corresponds exactly to the first touch control electrode lead wire 41. The lower surface of the first cylindrical spacers 11 contacts the upper surface of the film layer 6 located on the first touch control electrode lead wire 41. That is, the projection of the first cylindrical spacer 11 on the film layer 6 corresponds to the first touch control electrode lead wire 41, and the first cylindrical spacer 11 supports between the color filter substrate 1 and the film layer 6. The first cylindrical spacer is used for supporting the color filter substrate 1 and the thin film transistor array substrate 2 to maintain a distance between them. The standing position of second cylindrical spacer 12 corresponds exactly to the second touch control electrode lead wire 42, and the lower surface of the first cylindrical spacers 12 does not touch on the upper surface of the film layer 6 right located on the second touch control electrode 42. The projection of the second cylindrical spacer 12 on the film layer 6 corresponds to the second touch control electrode lead wire 42, and a distance is kept between the film layer 6 and the second cylindrical spacer 12.

In the embodiment, the grooves of the planarization layer are formed by etching the planarization layer with a half tone mask. In addition, referring to FIGS. 6 and 8, a plurality of openings 5 are defined in the planarization layer and passing through the planarization layer so that a ITO layer in the thin film transistor array substrate contacts with a corresponding electrode.

Referring to FIG. 9, when the color filter substrate 1 matches to the thin film transistor array substrate 2 face to face to be combined to form the touch control display panel, although a deviation occurs that the first cylindrical spacer 11 corresponds to the first touch control electrode lead wire 41 slightly inaccurately, the first cylindrical spacer 11 is still located on the film layer 6. Thus, the combination of the color filter substrate and the thin film transistor array substrate with such a deviation will not cause a change in the thickness of the combination structure, thereby ensuring the quality and the effect of the touch control display panel.

In addition, a manufacturing method of the thin film transistor array substrate in accordance with an embodiment is provided. The method includes following steps.

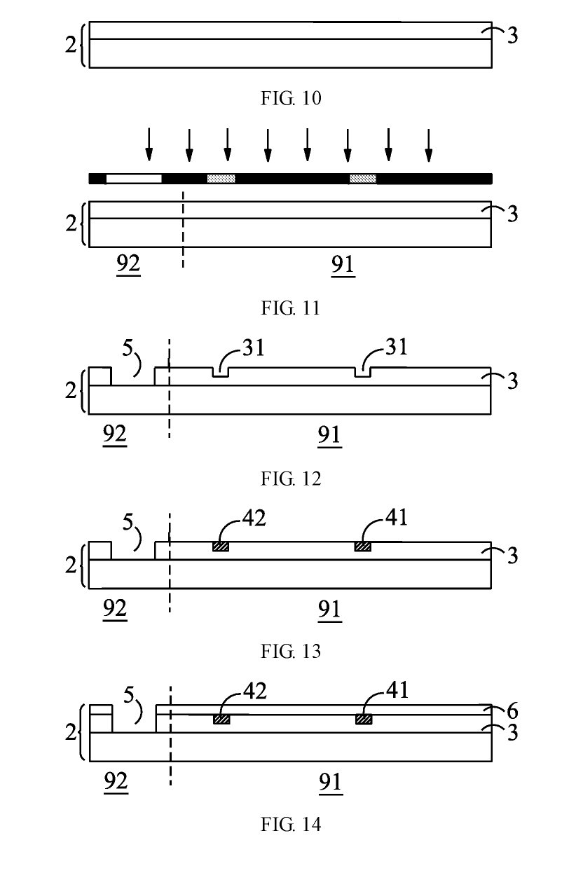

Step 1, as shown in FIG. 10, a thin film transistor array substrate 2 with a planarization layer 3 is provided.

Step 2, shown in FIG. 11, the thin film transistor array substrate 2 is divided into a first area 91 located at the right side and a second area 92 located at the left side, the planarization layer 3 in the first area 91 is incompletely exposed via a half tone mask, and the planarization layer 3 in the second area 92 is exposed completely via a common mask.

Step 3, shown in FIG. 12, the exposed planarization layer 3 is developed to enable an upper surface of the planarization layer 3 in the first area 91 to be recessed toward inner side to form grooves 31, and to enable the planarization layer 3 in the second area 92 to form openings 5 passing through the planarization layer 3.

Step 4, a metal layer is deposited on the planarization layer 3 based on a physical vapor deposition method (PVD). It is understand that the metal layer is not only deposited on the upper surface of the planarization layer 3 but also deposited in the grooves. As shown in FIG. 13, the metal layer is etched to remove a part of the metal layer located on the upper surface of the planarization layer 3 and maintain a part of the metal layer received in the grooves 31, which forms touch control electrode lead wires. The touch control electrode lead wires include a first touch control electrode lead wire 41 and a second touch control electrode lead wire 42, and the upper surfaces of the first and second touch control electrode lead wires 41, 42 and the upper surface of the planarization layer 3 are in the same plane.

Referring to FIG. 14, a film layer 6 is deposited and formed on the planarization layer 3 and the touch control electrode lead wires. The film layer 6 is planar because the upper surfaces of the first and second touch control electrode lead wires 41, 42 and the upper surface of the planarization layer 3 are in the same plane.

In the embodiment, the film layer 6 may be a passivation layer or may include a combination of a passivation layer and an ITO film layer formed on the passivation layer. Since each of the film layers mentioned above is a common structure in related art, the redundant description will be omitted herein.

Further, for a person skilled in the art, obviously, the present invention is not limited to the above exemplary embodiments disclosed herein. Besides, without deviating the spirit and the basic feature of the present invention, other specific forms can also achieve the present invention. Therefore, no matter from what point of view, the embodiments should be deemed to be exemplary, not limited. The range of the present invention is limited by the claims not by the above description. Accordingly, the embodiments are used to include all variation in the range of the claims and the equivalent requirements of the claims. It should not regard any reference signs in the claims as a limitation to the claims.

Besides, it can be understood that, although the present disclosure is describe according to the embodiments, each embodiment does not include only on dependent technology solution. The description of the present disclosure is only for clarity. The person skilled in the art should regard the present disclosure as an entirety. Technology solutions in the embodiments can be adequately combined to form other embodiments that can be understood by the person skilled in the art.

What is claimed is:

1. A thin film transistor array substrate, the thin film transistor array substrate having a planarization layer therein, the planarization layer being recessed to form a plurality of grooves arranged at intervals, a plurality of touch control electrode lead wires received in the plurality of grooves, and upper surfaces of the touch control electrode lead wires and an upper surface of the planarization layer being in a same plane.

2. The thin film transistor array substrate according to claim 1, wherein the plurality of grooves are formed by exposing and developing the planarization layer via a half tone mask.

3. The thin film transistor array substrate according to claim 1, wherein the planarization layer defines an opening passing through the planarization layer, and the opening is formed by exposing and developing the planarization layer via a common mask.

4. A manufacturing method of a film transistor array substrate, the manufacturing method comprising:
providing a thin film transistor array substrate having a planarization layer;
exposing and developing the planarization layer to enable the planarization layer to be recessed toward inner side to form a plurality of grooves arranged at intervals;
forming a touch control electrode lead wire in each groove to enable an upper surface of the touch control electrode lead wire and an upper surface of the planarization layer to be in a same plane.

5. The manufacturing method according to claim 4, wherein the thin film transistor array substrate is divided into a first area and a second area, and the exposing and developing the planarization layer comprises: incompletely exposing the first area of the planarization layer via a halt tone mask; and developing the planarization layer to form the plurality of grooves.

6. The manufacturing method according to claim 5, wherein the exposing and developing the planarization layer further comprises: completely exposing the second area of the planarization layer via a common mask; and developing the planarization layer to form an opening passing through the planarization layer.

7. The manufacturing method according to claim 6, wherein the forming a touch control electrode lead wire in each of the grooves comprises: depositing a metal layer on the planarization layer having the grooves; and etching the metal layer to remove a part of the metal layer located on the upper surface of the planarization layer, thereby remaining a part of the metal layer received in the grooves as the touch control electrode lead wires.

8. A touch display panel comprising:
a color filter substrate;
a thin film transistor array substrate disposed opposite to the color filter substrate;
a liquid crystal layer placed between the color filter substrate and the thin film transistor array substrate;
a plurality of photo spacers extending from a lower surface of the color filter substrate towards the thin film transistor array substrate; and
a planarization layer placed on an upper surface of the thin film transistor array substrate;
wherein the planarization layer is recessed to form a plurality of grooves arranged at intervals; a plurality of touch control electrode lead wires are received in the plurality of grooves respectively; upper surfaces of the plurality of touch control electrode lead wires and an upper surface of the planarization layer are in the same plane; all or a part of the plurality of photo spacers support between the color filter substrate and the thin film transistor array substrate; and
projections of the plurality of photo spacers on the thin film transistor array substrate correspond to the plurality of touch control electrode lead wires, respectively.

9. The touch display panel according to claim 8, further comprising a film layer located on the planarization layer and the touch control electrode lead wires, wherein the film layer is planar; and all or a part of the plurality of photo spacers support between a lower surface of the color filter substrate and an upper surface of the film layer.

10. The touch display panel according to claim 9, wherein the plurality of photo spacers comprise a first cylindrical spacer and a second cylindrical spacer, and a height of the first cylindrical spacer is higher than a height of the second cylindrical spacer along a direction substantially perpendicular to the color filter substrate; the plurality of touch control electrode lead wires comprises a first touch control electrode lead wire and a second touch control electrode lead wire; the first cylindrical spacer supports between the color filter substrate and a part of the film layer where the first touch control electrode lead wire is located right below; the second cylindrical spacer is located above a part of the film layer where the second touch control electrode lead wire is located right below; and the second touch control electrode lead wire keeps a distance with the film layer.
